(19) United States
(12) Patent Application Publication
(10) Pub. No.: US 2026/0067928 A1
(43) Pub. Date: Mar. 5, 2026

(54) INITIAL CONTROL FRAME FORMAT SOLICITING A NON-TB PPDU

(71) Applicant: NXP USA, Inc., AUSTIN, TX (US)

(72) Inventors: Liwen Chu, San Ramon, CA (US); Huizhao Wang, San Jose, CA (US); Ken Kinwah Ho, San Jose, CA (US); Hongyuan Zhang, Fremont, CA (US)

(21) Appl. No.: 19/317,698

(22) Filed: Sep. 3, 2025

Related U.S. Application Data
(60) Provisional application No. 63/690,115, filed on Sep. 3, 2024.
(60) Provisional application No. 63/752,148, filed on Jan. 31, 2025.
(60) Provisional application No. 63/762,250, filed on Feb. 24, 2025.

(51) Int. Cl. H04W 74/0808; H04W 28/02

(52) U.S. Cl. CPC H04W 74/0808; H04W 28/0278

(57) ABSTRACT

Methods and apparatus are described for exchanging an Initial Control Frame (ICF) and an Initial Control Response frame (ICR) between devices of a wireless network. A first wireless device generates an ICF that includes an indication configured to solicit a responsive non-High Throughput duplicate physical layer protocol data unit (non-HT duplicate PPDU) from a second wireless device. The first wireless device subsequently transmits the ICF, during a transmit opportunity (TXOP), for receipt by the second wireless devices. In various embodiments, the first wireless device further receives an ICR in the responsive non-HT duplicate PPDU.

### CROSS REFERENCE TO RELATED APPLICATIONS

The present U.S. Utility patent application claims priority pursuant to 35 U.S.C. § 119 (e) to U.S. Provisional Application No. 63/690,115, entitled “ICF FRAME FORMAT SOLICITING NON-TB PPDU”, filed Sep. 3, 2024, U.S. Provisional Application No. 63/752,148, entitled “ICF, ICR TBDs”, filed Jan. 31, 2025, and U.S. Provisional Application No. 63/762,250, entitled “ICF (Initial Control Frame) ICR (Initial Control Responding Frame)”, filed Feb. 24, 2025, the contents of each of which is hereby incorporated herein by reference in its entirety and made part of the present U.S. Utility patent application for all purposes.

### TECHNICAL FIELD

This disclosure relates generally to wireless communications, and more specifically to soliciting initial control information between wireless devices of a network.

### BACKGROUND

Wireless local area networks (WLANs) have evolved rapidly over the past couple of decades, including WLANs that conform to the Institute of Electrical and Electronics Engineers (IEEE) 802.11 family of standards. A typical 802.11-based WLAN is formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP. Control information is used in a WLAN to manage and optimize such wireless communications.

More recent versions of the IEEE 802.11 standards have added support for trigger-based uplink communications to enhance network throughput. For example, the 802.11ax amendment to the IEEE 802.11 standard introduced a Trigger frame format that can be used to solicit trigger-based (TB) physical layer (PHY) protocol data units (PPDUs) from one or more client devices. A Trigger frame allocates wireless channel resources for uplink transmission of the TB PPDUs and indicate to client devices how the TB PPDUs are to be configured.

### BRIEF DESCRIPTION OF THE DRAWINGS

One or more embodiments will now be described by way of example only with reference to the accompanying drawings, in which:

FIG. 1 illustrates an example of a multi-link communications system in accordance with embodiments of the present disclosure;

FIG. 2 illustrates an example format of a modified Trigger frame utilized as an Initial Control Frame (ICF) in accordance with embodiments of the present disclosure;

FIG. 3 illustrates an example of a Common Info field of a modified Trigger frame that is configurable to solicit a responsive non-Trigger-Based physical layer protocol data unit (non-TB PPDU) in accordance with embodiments of the present disclosure;

FIG. 4 illustrates an example of a Special User Info field format of a modified Trigger frame that is configurable to solicit a responsive non-TB PPDU in accordance with embodiments of the present disclosure;

FIG. 5 illustrates an example of an Initial Control Response (ICR) Multi-STA Block Acknowledgement (Multi-STA BA) frame including one or more Per AID TID Info fields in accordance with embodiments of the present disclosure;

FIG. 6 illustrates an example of a Per AID TID Info field of FIG. 5 in accordance with an embodiment of the present disclosure;

FIG. 7 illustrates an ICF/ICR frame exchange sequence between a TXOP holder and TXOP responder in accordance with an embodiment of the present disclosure;

FIG. 8 is a flow chart illustrating an example method for communicating dynamic control information in accordance with an embodiment of the present disclosure;

FIG. 9 is a flow chart illustrating an example method for communicating an Initial Control Response frame (ICR) in a non-HT duplicate PPDU in accordance with an embodiment of the present disclosure; and

FIG. 10 illustrates an example of an access point according to an embodiment of the present disclosure.

### DETAILED DESCRIPTION

The various implementations described in the following description relate generally to new or updated frame formats and methodologies for efficiently exchanging initial/dynamic/feedback control information between wireless devices of a wireless network. More particularly, innovative frame formats (e.g., Trigger frame formats and Multi-STA Block Ack frame formats) are described to support networking features such as enhanced power saving features, in-device coexistence features, switching between capability modes, and other features associated with the IEEE 802.11bn amendment to the IEEE 802.11 standard (also referred to as Ultra High Reliability or “UHR” or “Wi-Fi 8”) and future (or earlier) generations of the IEEE 802.11 standard.

In an example, a first wireless device generates an Initial Control Frame (ICF) that includes an indication configured to solicit a responsive non-Trigger-Based physical layer protocol data unit (non-TB PPDU) (e.g., a non-HT duplicate PPDU) from a second wireless device. Briefly, a Trigger-Based PPDU is a type of PPDU that is transmitted, generally without CSMA/CA contention, in response to and as scheduled by a Trigger Frame, while a non-TB PPDU is initiated by a device using standard EDCA/CSMA/CA and includes single user (SU) transmissions. The first wireless device subsequently transmits the ICF (e.g., during a transmit opportunity (TXOP)) for receipt by the second wireless devices. In various embodiments, the first wireless device further receives an Initial Control Response frame (ICR) in a responsive non-High Throughput non-HT duplicate PPDU (non-HT duplicate PPDU). The ICF may be a protected/unprotected Trigger frame (e.g., a Buffer Status Report Poll (BSRP) Trigger frame), and the ICR is a protected/unprotected Multi-STA Block Ack frame (also referred to herein as “Multi-STA BA” or “M-BA” frame).

As used herein, the term “non-legacy” may refer to physical layer protocol data unit (PPDU) formats and communication protocols conforming with the IEEE 802.11bn amendment to the IEEE 802.11 standard (“802.11bn”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard. In some implementations, the frame formats described herein may be configurable to support multiple versions of the IEEE 802.11 standard.

As used herein, initial/dynamic/feedback control information generally refers to dynamic control information being exchanged at the start of a TXOP. Initial control information may establish a feedback context, and typically remains fixed in a TXOP or for a future one-time event (e.g., an unavailable event), and can be updated with new initial/dynamic/feedback control information (e.g., prior to occurrence of the event). The initial control information may remain fixed for the duration of a TXOP, e.g., for controlling a dynamic power save feature. Dynamic control information generally refers to control data (e.g., for power saving operations, in-device coexistence mechanisms, modulation rates, etc.) that may change or be adjusted to account for current network conditions and requirements.

Particular implementations of the subject matter described in the present disclosure can be implemented to realize one or more of the following potential advantages. By improving and expanding control information exchange capabilities (particularly in Control frames), the described frame formats and methods enhance support for networking features such as enhanced power saving features, in-device (radio) coexistence features, per TXOP Tx/Rx parameter negotiation and TXOP allocations, etc. Further, the novel frame formats described herein can be defined for use in existing Control frame types, thereby avoiding the need to define a new Control frame(s). In addition, the frame formats and methods described herein help enable gains in overall network throughput (particularly in high-density environments) that will be achievable in accordance with the IEEE 802.11bn amendment of the IEEE 802.11 standard.

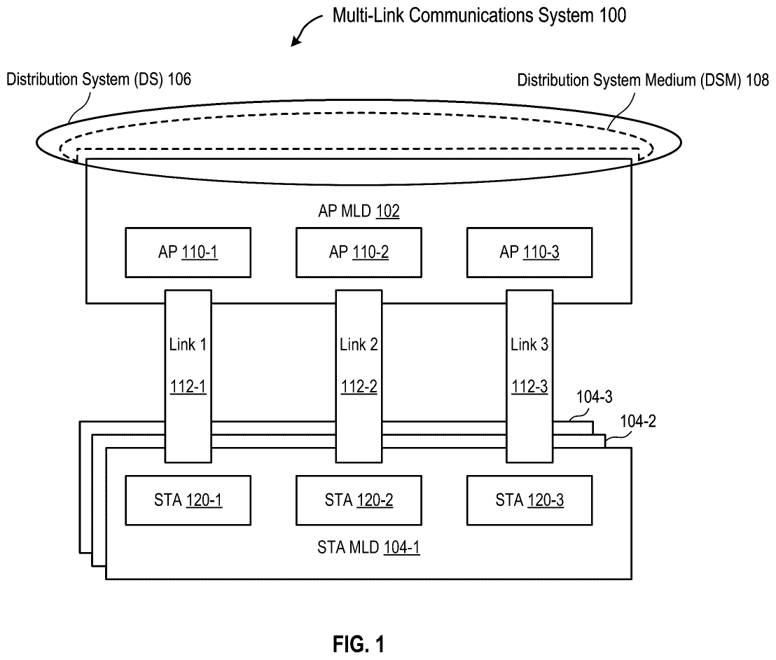

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices (which may also be referred to as a “non-AP MLD” or “STA MLD”), which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as, multiple AP MLDs and multiple STA MLDs, a single AP MLD and a single STA MLD. In another example, the multi-link communications system includes more than three STA MLDs and/or less than three STA MLDs. Although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, and 110-3, implement lower layer MAC functionalities (e.g., backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 104 may operate in the same different frequency bands. For example, at least one of the APs 110-1, 110-2, or 110-3 of the AP MLD 104 operates in an Extremely High Frequency (EHF) band or the “millimeter wave (mm Wave)” frequency band. In some embodiments, a mmWave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 2.4/5 GHz band (e.g., with a 20/40/80/160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band or different frequency bands. For example, at least one of the STAs 120-1, 120-2, or 120-3 of the STA MLD 104-1 operates in the mm Wave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 2.4/5 GHz band (e.g., with a 20/40/80/160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the wireless communications links in the multi-link communications system include one or more 2.4 GHz, 5 GHZ, 6 GHZ, 45 GHz and/or 60 GHz links.

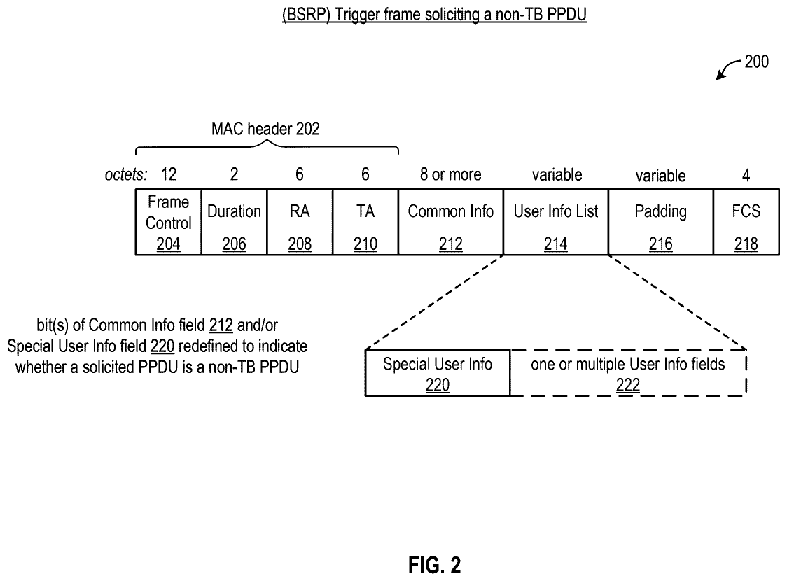

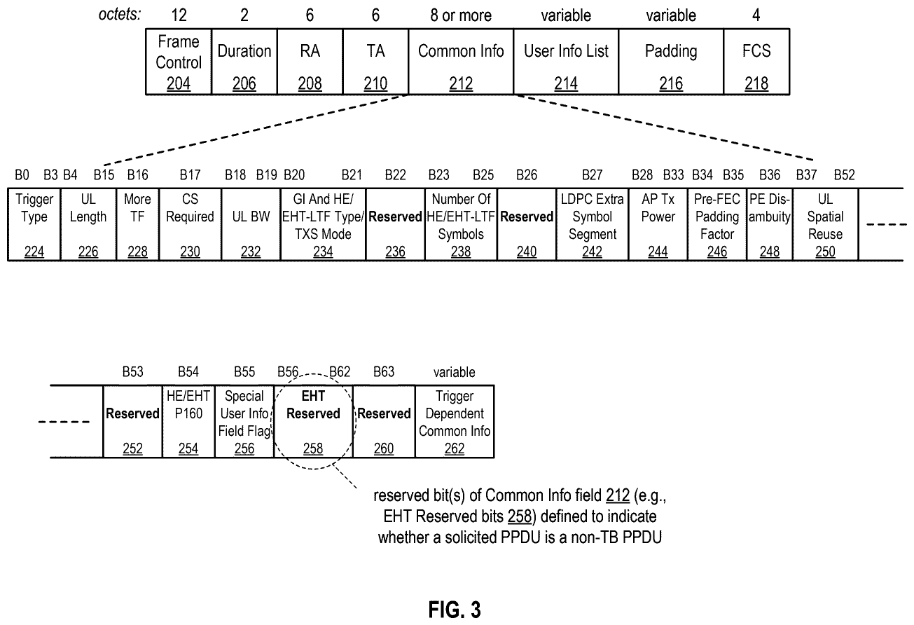

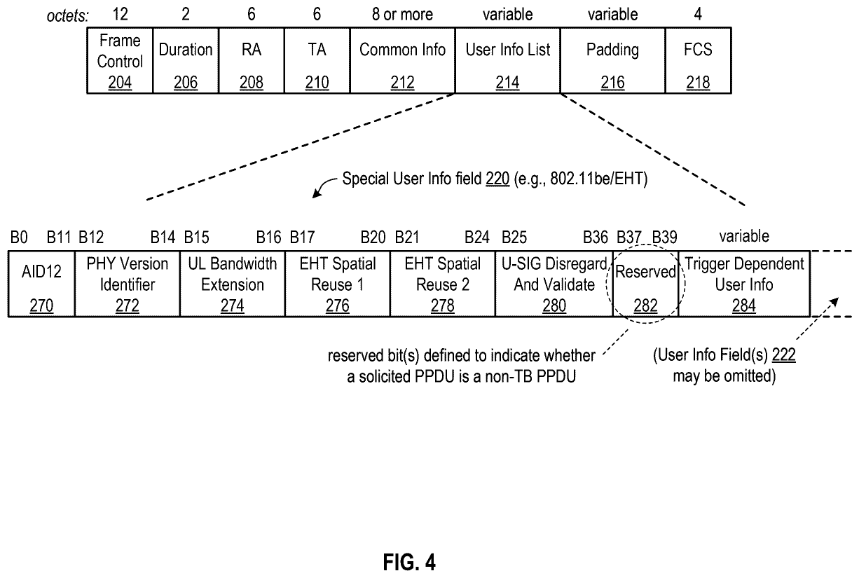

FIG. 2 illustrates an example format of a modified Trigger frame 200 utilized as an Initial Control Frame (ICF) in accordance with embodiments of the present disclosure. As described more fully below, a legacy reserved bit (or a reserved value in a field) in the Common Information field or the Special User Information field of the Trigger frame 200 (see, e.g., FIG. 3 and FIG. 4) is defined to indicate whether a solicited PPDU is a non-TB PPDU.

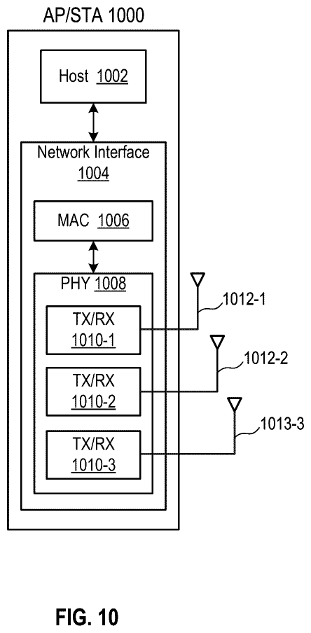

In an example, the Trigger frame 200 is a MAC Control frame included in a PPDU generated by an access point (e.g., an AP affiliated with the AP MLD 102 or a STA affiliated with the STA MLD 104 described with reference to FIG. 1 or the wireless device 1000 described with reference to FIG. 10), and can be transmitted to one STA/AP or a plurality of client STAs (i.e., recipient wireless device(s)). In addition to dynamic control information (or initial control information, feedback control information, feedback information, or dynamic initial control information), the Trigger frame 200 may include resource unit allocation indications and other transmission parameters to be used for transmission of an uplink OFDMA or UL MU MIMO data unit during a transmit opportunity (TXOP). The Trigger frame 200 may be included in a PPDU that conforms with the IEEE 802.11bn, 802.11be, 802.11ax or other amendment to the IEEE 802.11 standard. In some examples, the Trigger frame 200 can be used by a non-AP STA to solicit a non-TB PPDU(s) carrying various feedback control information in a Control frame. The Trigger frame 200 of this embodiment may include additional fields and capabilities as specified in IEEE 802.11be (e.g., a Special User Information (Info) field) and future amendments to the IEEE 802.11 standard, including IEEE 802.11bn.

The illustrated Trigger frame 200 includes a MAC header 202, a Common Information (“Common Info”) field 212, a User Information (“User Info”) List field 214, a padding field 216, and a frame check sequence (FCS) field 218. The MAC header 202 includes a Frame Control field 204, a Duration field 206 (containing information for timing synchronization or identification), a receiver address (RA) field 208, and a transmitter address (TA) field 210. In an example, the Common Info field 212 and User Info List field 214 carry configuration information which may be used by a receiving device to configure a TB PPDU that is transmitted in response to receiving the Trigger frame 200 (unless the Trigger frame solicits a non-TB PPDU). In an example, the User Info List field 214 may include one or more User Information (“User Info”) fields, each of which (if included) carries per-User information for a respective user, except for a Special User Info field that carries information that is common for multiple or all recipients, and/or an (optional) Feedback User Info field that carries dynamic control information. The Common Info field 212 may carry information (such as parameters for a TB PPDU transmission) that is common to all recipients (e.g., any users associated with User Info fields of the User Info List field 214) of the Trigger frame 200. The number of octets of bits allocated to each field of the Trigger frame 200, according to this example, is indicated in FIG. 2 above the corresponding field.

In an example, the Frame Control field 204 includes a plurality of subfields including a type subfield indicating that the frame is a Control frame and a subtype subfield indicating a subtype (e.g., a value of 4 for a BSRP trigger type) of the frame. In another example, the (legacy) FCS field 218 is a 32-bit field containing a 32-bit CRC value. The FCS is calculated over all the fields (i.e., “calculation fields”) of the MAC header and the frame body fields. The FCS value may be calculated and appended to a Trigger frame by an AP prior to transmission. Upon receipt of the Trigger frame by a client device, the client device can calculate an FCS value for the frame and compare it with the FCS value calculated by the AP. If the two FCS values match, it is assumed that the frame was not corrupted during transmission. If the two FCS values are different, an error is assumed and the frame is discarded. In addition, the Trigger frame 200 may carry an intermediate FCS value(s) in two I-FCS User Info fields preceding the padding field 216.

In part, the variable length padding field 216 is present in the Trigger frame 200 to extend the frame length for the following purposes: (1) to give the recipient STAs enough time to prepare a response (e.g., an Initial Control Response (ICR)) for transmission an SIFS after the frame is received and (2) to provide recipients sufficient time for a channel switch, an operating mode switch from a low capability mode to a high capability mode, etc. In some examples (not separately illustrated), the padding field 216 may be arranged to include various fields, such as a Common Initial Control Info Length field, a Common Initial Control Information field, a Packet Number (PN) field and a Message Integrity Check (MIC) field (e.g., when the Trigger frame 200 is a protected Trigger frame), a pre-padding/intermediate FCS field, additional padding, etc.

In general, the various frame arrangements and methodologies described herein relate to ICF/ICR exchanges in which an ICF (e.g., a BSRP Trigger frame) solicits feedback/dynamic control information from a single recipient in a non-TB PPDU. In an example, a BSRP Trigger frame from an AP is utilized to report its unavailable information or solicit unavailability information from a non-AP STA(s). When a single STA is addressed, the responsive PPDU can be a non-High Throughput (non-HT) duplicate PPDU or other non-TB PPDU (e.g., an Enhanced Long Range (ELR) PPDU, a High Efficiency (HE) PPDU, or an Extremely High Throughput (EHT) PPDU). In this example, the User Info field(s) 220 of the Trigger frame 200 may include one User Info field, or may not be needed and can be omitted. In another example, a non-AP STA can generate and transmit a BSRP Trigger frame (as an ICF) to an associated AP in order to report its unavailable information or solicit feedback information such as unavailability information. In this instance, the responding PPDU (e.g., carrying a Multi-STA BA frame) is not defined by a User Info field.

In various frame format examples described herein, a currently reserved bit (or a reserved value in a field) in a Common Information field or Special User Information field of a BSRP Trigger frame (see, e.g., FIG. 3 and FIG. 4) is defined to indicate whether a BRSP Trigger frame solicits a non-TB PPDU to carry an ICR having feedback information. In an example, the indication bit(s) may be defined to solicit a non-High Throughput (non-HT) duplicate PPDU. In another example, a wireless device addressed by the ICF may determine the type of the responsive non-TB PPDU from a plurality of non-TB PPDU types. Such non-TB PPDU types may include, without limitation, a non-High Throughput (non-HT) duplicate PPDU, an Enhanced Long Range (ELR) PPDU, a High Efficiency (HE) PPDU with MCS 14 (EHT duplicate), and an Extremely High Throughput (EHT) PPDU with MCS 15. In the following description, the indication bit(s) are generally described as soliciting a non-TB PPDU. However, the description is also applicable to embodiments in which the indication bit(s) solicit a specific type of PPDU, such as a non-HT duplicate PPDU.

FIG. 3 illustrates an example of a Common Info field of a modified Trigger frame that is configurable to solicit a responsive non-Trigger-Based physical layer protocol data unit (non-TB PPDU) in accordance with embodiments of the present disclosure. The various fields 204-218 of the illustrated Trigger frame correspond to the similarly labeled fields of Trigger frame 200 of FIG. 2.

In the illustrated Trigger frame, the Common Info field 212 includes a Trigger Type subfield 224, a UL Length subfield 226, a More TF subfield 228, a CS Required subfield 230, a UL BW 232, GI And HE/EHT-LTF Type/TXS Mode subfield 234, Reserved bit 236, Number of HE/EHT-LTF Symbols subfield 238, a Reserved bit 240, LDPC Extra Symbol Segment subfield 242, AP Tx Power subfield 244, Pre-FED Padding Factor subfield 246, PE Disambiguity subfield 248, UL Spatial Reuse subfield 250, Reserved bit 252, HE/EHT P160 subfield 254, Special User Info Field Flag 256, EHT Reserved bits 258, Reserved bit 260, and variable length Trigger Dependent Common Info subfield 262. The CS Required (Carrier Sense Required) subfield 230 tells a recipient STA(s) whether a clear-channel assessment (CCA) is required before transmitting a reply, and is useful if a TXOP holder would like TXOP protection similar to RTS/CTS. The UL BW subfield specifies channel width information that the addressed recipient device uses to determine the bandwidth of a responsive PPDU (e.g., for an uplink ICR).

In this example, one or more legacy Reserved bits of the Common Info field 212 are (re) defined to indicate whether the BRSP Trigger frame solicits a non-TB PPDU to carry an ICR having feedback information. In an example, a bit of the EHT Reserved bits 258 is utilized as the indication for a non-TB PPDU to carry the ICR. In other examples, a Reserved bit 236, 240, 252 or 260 is defined as an indication bit. In another example, the Common Info field 212 includes an explicit indication of the type of feedback that is solicited. In a further example, the Common Info field 212 and/or Padding field 216 carries security related information (e.g., Key ID, Protection Indication, etc.) when the BSRP Trigger frame is a protected frame. In another example, two I-FCS User Info fields (not separately illustrated) are included before the Padding field 216 to carry an intermediate FCS.

FIG. 4 illustrates an example of a Special User Info field format of a modified Trigger frame that is configurable to solicit a responsive non-TB PPDU in accordance with embodiments of the present disclosure. The illustrated Special User Info field 220 (e.g., a modified 802.11be Special User Info field) includes an AID12 subfield 270 consisting of 12 bits, a PHY Version Identifier subfield 272 consisting of 3 bits, a UL Bandwidth Extension subfield 274 consisting of 2 bits, an EHT Spatial Reuse 1 subfield 276 consisting of 4 bits, an EHT Spatial Reuse 2 subfield 278 consisting of 4 bits, a U-SIG Disregard And Validate subfield 280 consisting of 12 bits, Reserved bits 282 consisting of 3 bits, and a Trigger Dependent User Info subfield 264 of variable length. The UL Bandwidth Extension subfield 274 provides information that may be utilized, for example, by a TXOP responder AP or single non-AP STA to determine the bandwidth of a responsive PPDU. In this example, one or more bits of Reserved bits 282 may be defined to indicate whether a solicited PPDU is a non-TB PPDU. In another example, legacy Reserved bits of the Common Info field 212 may be repurposed to provide such information.

In another example, the User Info Field(s) 222 of FIG. 2 may be omitted when the Trigger frame/ICF solicits a non-TB PPDU and is addressed to a single recipient wireless device. In this example, when the modified Trigger frame (e.g., a BSRP Trigger frame) is a downlink (DL) ICF that solicits a non-TB PPDU from a single recipient/TXOP responder, the RA field 208 includes a unicast address that corresponds to the TXOP responder's MAC address. In another example, when the Trigger frame is an uplink (UL) ICF that solicits a non-TB PPDU from a second wireless device, the RA field 208 includes a unicast address (e.g., the BSSID of an addressed AP) that identifies the second wireless device. In another example, the BSRP Trigger frame includes a dummy User Info field carrying the recipient's AID.

In an example, the various types of dynamic control information (or initial control information or feedback control information) can be organized through Type+Length+Content tuples. In another example, a resource request is similarly carried in one Type+Length+Content tuple. In further examples, the various types of dynamic control information can be organized through Type+Content tuples, and a resource request can be organized through a Type+Content tuple. Further, an ICF/ICR may carry multiple Type+Length+Content tuples for multiple types of common dynamic control information, where the different types of dynamic/initial/feedback control information are carried in different Feedback Per AID TID Info fields and each Per AID TID Info field is organized through Type+Length+Content. For each Feedback User Info field, only one type of dynamic/initial/feedback control information is carried. Further, for the option of Type+Content, the Type+Content tuples defined in UHR/Wi-Fi 8 can be carried before Type+Content tuples defined for a next amendment to the 802.11 standard (e.g., NG-UHR, Wi-Fi 9) for purposes of backwards compatibility. For example, when a UHR (or later) STA receives a Type+Content tuple that it does not recognize, the STA may stop decoding the following Type+Content tuple(s), if any, in an ICF/ICR.

In another example, when a wireless device transmits a BSRP Trigger frame that solicits dynamic control information from a STA, the STA needs to be allocated sufficient resources for decoding the BSRP Trigger frame and preparing a response that includes the solicited dynamic control information. If the BSRP Trigger frame also solicits a resource request from the STA, the allocated resources are also sufficient to include the resource request in the response. If an addressed STA does not have information to report for a solicited type of information, a response/ICR from the STA may omit the related Type+Length+Content tuple or, alternatively, carry the related Type+Length+Content tuple with a value in a Content field of the responding ICR that indicates no information is reported.

In a further example, when a BSRP Trigger frame solicits dynamic control information from a recipient (addressed) wireless device, the BSRP Trigger frame may explicitly indicate the solicited type(s) of dynamic control information (e.g., via a redefined bit(s) of a Common Info field or Special User Info field). In another example, whether or not the dynamic information is solicited is implicitly determined by whether or not the recipient of the BSRP Trigger frame enables the related feature. Accordingly, the addressed STA is allocated sufficient resources by the BSRP Trigger frame to prepare a (non-) TB PPDU carrying all of the solicited dynamic control information supported by the STA. If the BSRP Trigger frame also solicits a resource request from the STA, the allocated resources are further sufficient to include the resource request in the (non-) TB PPDU. In an example, one Per AID TID Info field in a Multi-STA BA frame (as the feedback ICR) carries a buffer status. As described herein, if an addressed STA does not have information to report for a solicited type of information, a responsive ICR from the STA may omit the related Type+Length+Content tuple or, alternatively, carry the related Type+Length+Content tuple with an invalid or predefined value in a Content field of the responding (non-) TB PPDU. In an example, a Multi-STA BA frame as a feedback ICR carries at least one Per AID TID Info field.

In another example, when a BSRP Trigger frame solicits dynamic control information and/or a resource report from a peer wireless device, and responsive dynamic control information is carried in a non-TB PPDU, the transmit opportunity (TXOP) holder can calculate the length of the responsive PPDU based on the primary Modulation Coding Scheme (MCS) and the length of the solicited dynamic control information. The allocated resources of the responsive PPDU may be further based on the length of a solicited resource request and is sufficient to carry a Multi-STA BA frame and QoS Null frame if a TB PPDU is solicited, or sufficient to carry a Multi-STA BA frame is a non-TB PPDU is solicited. If a peer device does not have information to report for a solicited type of information, a responsive PPDU may omit the associated Type+Length+Content tuple in a Multi-STA BA frame (ICR) or, alternatively, carry the related Type+Length+Content tuple with a value (e.g., all zeroes or all ones) in a Content field of the responding PPDU that is interpreted by a recipient wireless device to indicate that no information is reported. In a still further example, when a responding device supports at least one feature related to a received ICF or BSRP Trigger frame (e.g., a low-capability listening mode) but does not support transmission of dynamic control information, the responding device may transmit a responsive Multi-STA BA with no BA bitmap and a QoS Null frame (e.g., when responding in a TB PPDU). Further examples are described below.

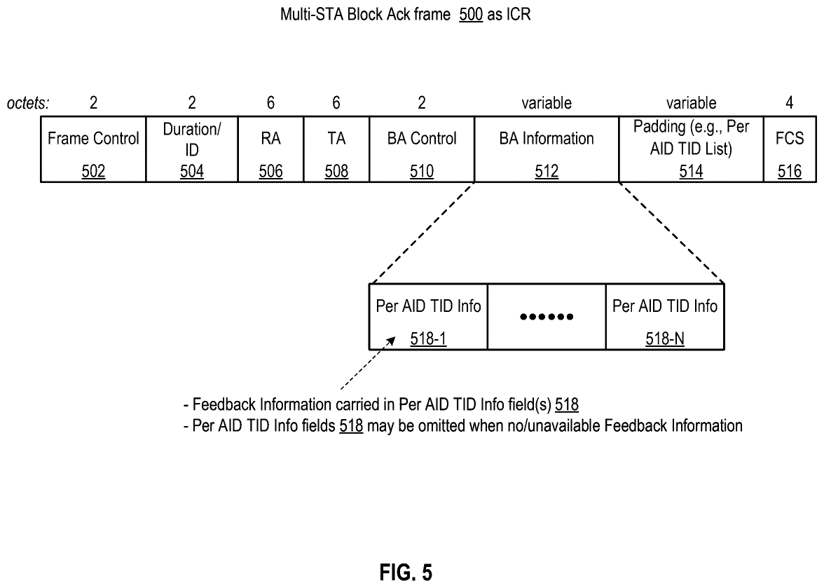

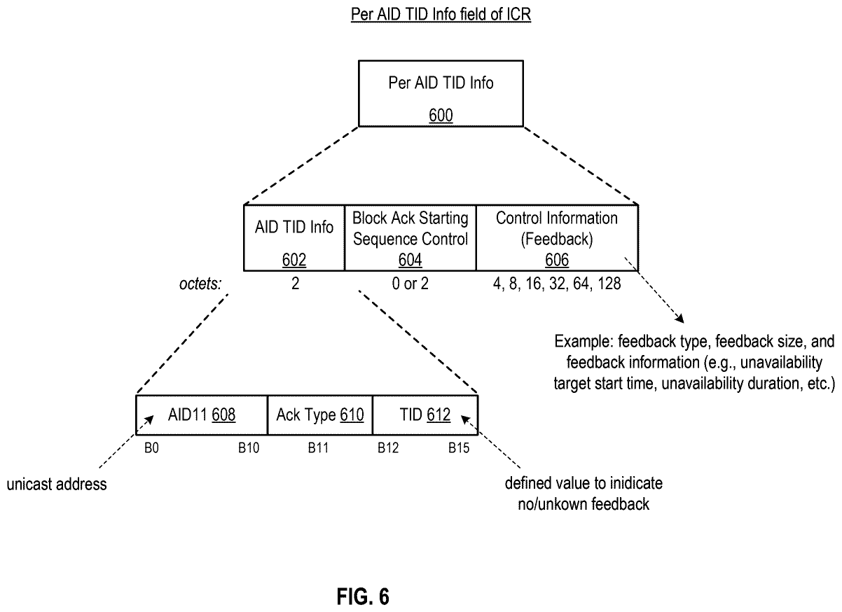

FIG. 5 illustrates an example of an Initial Control Response (ICR) Multi-STA Block Acknowledgement (Multi-STA BA) frame 500 including one or more Per AID TID Info fields 518 in accordance with embodiments of the present disclosure. The Multi-STA BlockAck frame 500 of the illustrated example includes a plurality fields, including a Frame Control field 502, a Duration/ID field 504, an RA field 506, a TA field 508, a BA Control field 510, a BA Information field 512 including one or more Per AID TID Info fields 518, a padding field 514 (e.g., including Per AID TID List padding), and an FCS field 516. An example of a format of a Per AID TID Info field 518 is described in greater detail with reference to FIG. 6.

In an example, the BA Information field 512 is only permitted to carry at least a single Per AID TID Info field 518 or, alternatively, no Per AID TID Info fields 518 for dynamic control information when feedback information is unknown or unavailable. In another example, the combination of Per AID TID Info fields 518 carries all of the required/solicited dynamic control information included in the (ICR) Multi-STA BA frame 500. The combination/omission of fields may result, for example, in reduced overhead (e.g., a reduced number of fields and/or unused bits) for communicating required feedback/dynamic control information.

FIG. 6 illustrates an example of a Per AID TID Info field 518 of FIG. 5 in accordance with an embodiment of the present disclosure. The Per AID TID Info field 600 of this example includes an AID TID Info field 602, a Block Ack Starting Sequence Control field 604, and a Control Information (feedback) field 606 (e.g., 4, 8, 16, 32, 64 or 128 octets) carrying requested dynamic control information, if any, of an ICR. For example, the Control Information field 606 may include information such as feedback type, feedback size, and feedback information (e.g., unavailability target start time, unavailability duration, etc.).

The AID TID Info field 602 of the illustrated example includes an AID11 subfield 608, an Ack Type subfield 610, and a Traffic Identifier (TID) subfield 612. In an example, the AID11 subfield 608 includes an AID value that is greater than 2007 when the Per AID TID Info field carries feedback information. In another example, the Ack Type subfield 610 is set to 0 when the Per AID TID Info field 600 carries feedback/dynamic control information, and is set to 1 when the Per AID TID Info field 600 does not carry feedback/dynamic control information. In a further example, the absence of a Per AID TID field 600 indicates that a Multi-STA BA frame does not carry feedback/dynamic control information.

With respect to a wireless device(s) that receives a BSRP Trigger frame such as described above, a response/ICR may take various forms depending, in part, on the type of information that is solicited and whether or not a non-TB PPDU is specified for the response. In an example in which a TB PPDU carries the response, a recipient wireless device can generate and transmit an A-MPDU that includes both a Multi-STA BA carrying dynamic control information and a QoS Null frame providing a buffer status report or UL transmit power headroom if a TB PPDU carries the response. Accordingly, the AP needs to allocate sufficient resources for the recipient of the BSRP Trigger frame to transmit the QoS Null frame and the Multi-STA BA frame in the responding TB PPDU. Otherwise, the Multi-STA BA carrying dynamic control information is in a responsive non-TB PPDU. In an example, the resource allocated for a Multi-STA BA frame assumes that the Multi-STA BA frame carries one Per AID TID Info with Ack Type equal to 1 (i.e., the Per AID TID Info field without a BA Bitmap) and one Per AID TID Info field for each type of feedback information. In further examples, a response includes a single Multi-STA BA carrying dynamic control information and a buffer status report, a single Multi-STA BA carrying dynamic control information, and/or a single QoS Null frame carrying a buffer status report.

With respect to the format of a PPDU that carries an ICR frame, if multiple STAs transmit a responding ICR frame, the responding ICR frames can be carried in a UHR TB PPDU. As described herein, however, if a single STA is solicited to transmit a responding ICR frame, the ICF can indicate whether the responding ICR frame is carried in a TB PPDU or non-TB PPDU (e.g., a non-HT duplicate PPDU). In addition, when an ICF is addressed to an associated AP, the responding PPDU from the AP can be a SU PPDU (e.g., a non-HT duplicate PPDU). In another example, when an ICF is addressed to single associated STA, the responding PPDU from the STA can be a (solicited) non-TB PPDU or a TB PPDU. The type of solicited PPDU can be indicated in a Common User Info field, a Special User Info field, or a Per-STA Initial Control Per AID TID Info field (not separately illustrated).

The frame formats and ICF/ICR exchanges described herein can support a number of new or revised features that under consideration for the 802.11bn amendment to the 802.11 standard. Such features may include but are not limited to Dynamic Power Save (DPS), Dynamic Sub-channel Operation (DSO), Non-Primary Channel Access (NCPA), and Dynamic Unavailability Operation (DUO), etc. Briefly, DPS allows a STA to dynamically switch between a low-capability (LC) mode and a higher-capability (HC) operating mode in order to save energy. DSO is a mechanism that adapts the allocation of sub-channels within a wide-band PPDU when client capabilities differ. NCPA allows compliant devices to switch to a secondary channel (NCPA primary channel) when a primary channel is busy in order to boost overall spectral efficiency. DUO is a mechanism to solicit a TXOP responder's unavailable information or to report a TXOP holder's unavailability information without soliciting. Such features may rely on the timely and efficient exchange of related dynamic control information between wireless devices. In the following description, various examples of the contents of a responsive Multi-STA BA frame are described for providing feedback/dynamic control information relating to various combinations of the foregoing features.

In a general case in which a Multi-STA BA frame is used as an ICR (or responding frame) solicited by a BSRP Trigger frame, the Multi-STA BA frame may not carry feedback information such as unavailable information. This may occur, for example, when the transmitter of the Multi-STA BA frame has no unavailable information to report, or when the feature enabled by the transmitter of the Multi-STA BA frame does not any feedback report (e.g., DPS being enabled, transmitting a Multi-STA BA frame in a NPCA primary channel, etc.). In this case, the frame body of the Multi-STA BA frame can be constructed in various ways. In a first example, the Multi-STA BA frame does not include any Per AID TID Info fields, and the RA field is set to the MAC address of a recipient wireless device. In another example, the Multi-STA BA frame includes one Per AID TID Info field with the AID11 subfield of the AID TID Info field being set to the recipient's AID. In this example, the Multi-STA BA frame is not allowed to carry no Per AID TID Info fields, and the AID11 subfield may have a value of 0 (zero) if the Multi-STA BA frame is addressed to an AP. Continuing with this example, the ACK Type field of the AID TID Info field is set to 1 when no Block Ack Starting Sequence Control field and Block Ack Bitmap are included in the Per AID TID Info field, and the TID field is set to a value greater than 7, e.g., 13. In this example, the RA field is set to the MAC address of a recipient device or a broadcast MAC address.

In another general case in which a Multi-STA BA frame is used as an ICR, the Multi-STA BA frame carries feedback (e.g., unavailable(ity) information). In this case, the frame body of the Multi-STA BA frame can be constructed in various ways. In a first example, the Multi-STA BA frame does not include any Per AID TID Info fields other than the special Per AID TID Info field including the (dynamic) feedback information, and the RA field is set to the MAC address of a recipient wireless device. In another example, in addition to the special Per AID TID Info field, the Multi-STA BA frame includes one Per AID TID Info field with the AID11 subfield of the AID TID Info field being set to the recipient's AID. In this example, the ACK Type field of the AID TID Info field is set to 1 when no Block Ack Starting Sequence Control field and Block Ack Bitmap are included in the Per AID TID Info field, and the TID field is set to a value greater than 7, e.g., 13. Continuing with this example, the RA field is set to the MAC address of a recipient device or a broadcast MAC address.

In another general case, a Multi-STA BA frame is used as an ICR to carry information relating to any of the features described above (DPS, DSO, NCPA, etc.) excluding Dynamic Unavailability Operation (DUO). In the specific case of Non-Primary Channel Access (NCPA) only, in a TXOP with a non-AP STA as the TXOP holder in the NPCA primary channel, the AP that receives a BSRP NTB Trigger frame transmits a Multi-STA BA frame without unavailable information. The frame body of the corresponding Multi-STA BA frame can be constructed in various ways. In a first example, the Multi-STA BA frame does not include any Per AID TID Info fields, and the RA field is set to the MAC address of a recipient wireless device. In another example, the Multi-STA BA frame includes one Per AID TID Info field with the AID11 subfield of the AID TID Info field being set to the recipient's AID. In this example, the Multi-STA BA frame is not allowed to carry no Per AID TID Info fields, and the ACK Type field of the AID TID Info field is set to 1 when no Block Ack Starting Sequence Control field and Block Ack Bitmap are included in the Per AID TID Info field, and the TID field is set to a value greater than 7, e.g., 13. Continuing with this example, the RA field is set to the MAC address of a recipient device or a broadcast MAC address.

In specific cases in which Multi-STA BA frame is used as an ICR to carry information relating to (NCPA+) DPS+CFP or DSO+CFP, the frame body of the Multi-STA BA frame can be constructed in various ways. In a first example, the Multi-STA BA frame does not include any Per AID TID Info fields, and the RA field is set to the MAC address of a recipient wireless device. In another example, the Multi-STA BA frame includes one Per AID TID Info field with the AID11 subfield of the AID TID Info field being set to the recipient's AID. In this example, the Multi-STA BA frame is not allowed to carry no Per AID TID Info fields, and the ACK Type field of the AID TID Info field is set to 1 when no Block Ack Starting Sequence Control field and Block Ack Bitmap are included in the Per AID TID Info field, and the TID field is set to a value greater than 7, e.g., 13. Continuing with this example, the RA field is set to the MAC address of a recipient device or a broadcast MAC address.

In another general case, a Multi-STA BA frame is used as an ICR to carry information relating to DUO or any combination of DUO and any other feature (DPS, DSO, NCPA, etc.). In this case, the Multi-STA BA carries a special Per AID TID Info field carrying unavailable time information of the responder, and the frame body of the Multi-STA BA frame can be constructed in various ways. In a first example, the Multi-STA BA frame does not include any Per AID TID Info fields other than the special Per AID TID Info field including the (dynamic) feedback information (e.g., unavailability information), and the RA field is set to the MAC address of a recipient wireless device. In a second example, in addition to the special Per AID TID Info field including the (dynamic) feedback information (e.g., unavailability information), the Multi-STA BA frame includes one Per AID TID Info field with the AID11 subfield of the AID TID Info field being set to the recipient's AID, the ACK Type field of the AID TID Info field is set to 1 when no Block Ack Starting Sequence Control field and Block Ack Bitmap are included in the Per AID TID Info field, and the TID field is set to a value greater than 7, e.g., 13. Continuing with this example, the RA field is set to the MAC address of a recipient device or a broadcast MAC address. In either of the first example or the second example, the device transmitting the ICR is allocated sufficient resources to prepare a Multi-STA BA frame that includes the contents described in the second example. For a special Per AID TID Info field that carries unavailability information as the feedback, the Per AID TID Info field (e.g., a 4-bit Type field) may carry a special value for an unavailable start time and/or unavailable duration. In addition, when an ICR Multi-STA BA frame is carried in a TB PPDU, a QoS Null is aggregated with the Multi-STA BA frame.

In a further general case, a QoS Null frame is transmitted by a STA under (NCPA+) DPS or (NCPA+) DSO or DSO+DPS mechanisms. The QoS Null frame may be in a TB PPDU, and functions as a response frame. In this case, the QoS Null frame may indicate a buffer status, the buffer status of the STA being unknown by the recipient device, or indicate the UL power headroom. In an example when DUO only or DUO and at least one of DSO, NPCA, DPS, EMLSR is used, a Multi-STA BA frame and QoS Null frame are transmitted (in a TB PPDU) by a STA in response to a BSRP Trigger frame, and the soliciting BSRP Trigger frame (as an ICF) allocates enough resources for each recipient to transmit a Multi-STA BA frame and QoS Null frame.

As noted above, a STA receiving an ICF should be allocated sufficient resources to prepare a (non-) TB PPDU carrying a Per AID TID Info field with Ack Type set to 1 and a TID field equal to 13, and all of the solicited dynamic control information supported by the STA. In an example, a TXOP holder that supports an unsolicited unavailable time report transmits an uplink (UL) ICF carrying unsolicited unavailable time information. When the TXOP responder does not support the report of unavailable time information, the soliciting ICF/BSRP Trigger frame shall allocate sufficient resources for a responsive Multi-STA BA frame to include a 2-octet Per AID TID Info field for acknowledgment, Per AID TID Info fields for PN and MIC values if control frame protection is required, and Per AID TID Info fields for padding if padding is required. When the TXOP responder supports the report of unavailable time information, the responsive Multi-STA BA frame shall be allocated (by the soliciting ICF) sufficient resources by the soliciting BSRP Trigger frame as ICF to include a Per AID TID Info field with Ack Type set to I and a TID field equal to 13, an 8-octet Per AID TID Info field for the unavailable information report, Per AID TID Info fields for PN and MIC values if control frame protection is required, and Per AID TID Info fields for padding if padding is required.

In another example, a TXOP holder transmits an ICF that does not carry unsolicited unavailable time information. The ICF may be used, for example, when the TXOP holder is in an NCPA primary channel, solicits a peer device's readiness for frame exchanges, solicits a peer device's readiness for frame exchanges and an unavailable time report without control frame protection, or solicits a peer device's readiness for frame exchanges and an unavailable time report under control frame protection. When the TXOP responder is solicited for the readiness for frame exchanges only, the responsive Multi-STA BA frame shall be allocated sufficient resources to include a 2-octet Per AID TID Info field for acknowledgment, Per AID TID Info fields for PN and MIC values if control frame protection is required, and Per AID TID Info fields for padding if padding is required. When the TXOP responder supports the report of unavailable time information, the responsive Multi-STA BA frame shall be allocated sufficient resources to include a 2 octet Per AID TID Info field for acknowledgment, an 8-octet Per AID TID Info field for the unavailable information report, Per AID TID Info fields for PN and MIC values if control frame protection is required, and Per AID TID Info fields for padding if padding is required.

In another example, a TXOP holder that supports an unsolicited unavailable time report transmits an uplink (UL) or downlink (DL) ICF to solicit a non-TB PPDU where the ICF carries unsolicited unavailable time information. In this example, the responding frame is carried in a non-HT duplicate PPDU. When the TXOP responder does not support the report of unavailable time information, the responsive Multi-STA BA frame shall be allocated sufficient resources by the soliciting BSRP Trigger frame/ICF to include a 2-octet Per AID TID Info field for acknowledgment, Per AID TID Info fields for PN and MIC values if control frame protection is required, and Per AID TID Info fields for padding if padding is required. When the TXOP responder supports the report of unavailable time information, the responsive Multi-STA BA frame shall be allocated sufficient resources by the soliciting BSRP Trigger frame/ICF to include a 2-octet Per AID TID Info field for acknowledgment, an 8-octet Per AID TID Info field for the unavailable information report, Per AID TID Info fields for PN and MIC values if control frame protection is required, and Per AID TID Info fields for padding if padding is required.

In a further example, a TXOP holder that supports an unsolicited unavailable time report transmits a downlink (DL) ICF to solicit a TB PPDU where the ICF carries unsolicited unavailable time information. In this example, the response includes Multi-STA BA frame and a QoS Null frame that are carried in a TB PPDU. Accordingly, the TXOP responder shall be allocated sufficient resources by the soliciting BSRP Trigger frame/ICF to include both frames in the TB PPDU. In a variant, the QoS Null frame is only carried when the TXOP responder supports the UL MU frame transmission in a TB PPDU. When the TXOP responder does not support the report of unavailable time information, the responsive Multi-STA BA frame shall be allocated sufficient resources by the ICF to include a 2-octet Per AID TID Info field for acknowledgment, Per AID TID Info fields for PN and MIC values if control frame protection is required, and Per AID TID Info fields for padding if padding is required. When the TXOP responder supports the report of unavailable time information, the responsive Multi-STA BA frame shall be allocated sufficient resources by the soliciting BSRP Trigger frame/ICF to include a 2-octet Per AID TID Info field for acknowledgment, an 8-octet Per AID TID Info field for the unavailable information report, Per AID TID Info fields for PN and MIC values if control frame protection is required, and Per AID TID Info fields for padding if padding is required.

In another example, a TXOP holder transmits a downlink (DL) or uplink (UL) ICF that does not carry unsolicited unavailable time information (e.g., used when the TXOP holder solicits an unavailable time report and/or supports control frame protection) to be carried in a non-TB PPDU. In this example, the responding frame is carried in a non-HT duplicate PPDU. When the TXOP responder does not support the report of unavailable time information, the responsive Multi-STA BA frame shall be allocated sufficient resources by the soliciting BSRP Trigger frame/ICF to include a 2-octet Per AID TID Info field for acknowledgment, Per AID TID Info fields for PN and MIC values if control frame protection is required, and Per AID TID Info fields for padding if padding is required. When the TXOP responder supports the report of unavailable time information, the responsive Multi-STA BA frame shall be allocated sufficient resources by the soliciting BSRP Trigger frame/ICF to include a 2-octet Per AID TID Info field for acknowledgment, an 8-octet Per AID TID Info field for the unavailable information report, Per AID TID Info fields for PN and MIC values if control frame protection is required, and Per AID TID Info fields for padding if padding is required.

In a further example, a TXOP holder transmits a downlink (DL) ICF to solicit a TB PPDU where the ICF does not carry unsolicited unavailable time information. In this example, the response includes Multi-STA BA frame and a QoS Null frame that are carried in a TB PPDU. Accordingly, the TXOP responder shall be allocated sufficient resources by the soliciting BSRP Trigger frame/ICF to include both frames in the TB PPDU. In a variant, the QoS Null frame is only carried when the TXOP responder supports the UL MU transmission in a TB PPDU. When the TXOP responder does not support the report of unavailable time information, the responsive Multi-STA BA frame shall be allocated sufficient resources by the soliciting BSRP Trigger frame/ICF to include a 2-octet Per AID TID Info field for acknowledgment, Per AID TID Info fields for PN and MIC values if control frame protection is required, and Per AID TID Info fields for padding if padding is required. When the TXOP responder supports the report of unavailable time information, the responsive Multi-STA BA frame shall be allocated sufficient resources by the soliciting BSRP Trigger frame/ICF to include a 2-octet Per AID TID Info field for acknowledgment, an 8-octet Per AID TID Info field for the unavailable information report, Per AID TID Info fields for PN and MIC values if control frame protection is required, and Per AID TID Info fields for padding if padding is required.

In various of the examples, when an unavailable time report is solicited from TXOP responder, the TXOP responder may have no unavailable time. The responsive frame may communicate the lack of unavailable time in different ways. In a first example, the Unavailability Target Start Time field includes a special value (e.g., all 0's or all 1's) to indicate no unavailable time. In a second example, a dedicated field-separate from the Unavailability Target Start Time field-explicitly indicates no unavailable time. In a third example, the Unavailability Duration field includes a value of 1 to indicate no unavailable time, and the Unavailability Target Start Time field may be reserved. In a fourth example, a responsive Multi-STA BA frame that does not include a Special User Info field implicitly indicates no unavailable time.

In various of the examples, when an unavailable time report is solicited from TXOP responder, the TXOP responder may not know the requested information. The responsive frame may communicate the unknown unavailable time in different ways. In a first example, the Unavailability Target Start Time field includes a special value (e.g., all 0's or all 1's) to indicate unknown unavailable time. In a second example, a dedicated field—separate from the Unavailability Target Start Time field-explicitly indicates unknown unavailable time. In a third example, the Unavailability Duration field includes a value of 1 to indicate unknown unavailable time, and the Unavailability Target Start Time field may be reserved. In a fourth example, a responsive Multi-STA BA frame that does not include a Special User Info field implicitly indicates unknown unavailable time.

At certain times, the unavailable time duration of a TXOP holder/TXOP responder may exceed a predetermined maximal unavailable time duration (e.g., 64×511 us). In an example, a maximal value in the Unavailability Duration field indicates an unavailable duration having the maximal value (e.g., 64×511 us or 64×510 us) or, alternatively, a duration greater than the maximal value (e.g., >64×511 us or >64×510 us). Likewise, the difference between a target start time and the current TSF time may be greater than maximal time duration (e.g., 64×511 us). In this example, the TXOP holder/TXOP responder may report an unknown unavailable time.

In IEEE 802.11, the Timing Synchronization Function (TSF) operates to align the local 64-bit counters (running at 1 MHz, one tick per microsecond) maintained by all STAs by having an AP or the STAs broadcast a local counter timestamp in beacon frames- and probe responses, and aligning to a highest value as the current TSF time. The TSF function is important for coordinated Wake/Sleep functions, slot-based features, and seamless roaming. TSF drift refers to a gradual divergence between a STA's internal timer and a reference network timer maintained by an AP (infrastructure mode) or by the fastest node (IBSS/ad hoc). TSF drift may occur, for example, when a STA misses a Beacon frame from an associated AP. Even without losing a Beacon frame, the TSF drift within one Beacon interval 100TU (one Time Unit (TU)=1.024 ms) under+/−100 ppm accuracy could be as large as 100TU×200/1,000,000=0.02 TU or 20 us).

In order to address such TSF asynchronization, a maximal target start time may use the current TSF time as the unavailable time. Conventionally, a full TSF field is eight octets, and the non-AP STA's current TSF time is partially expressed as its current TSF [14:6] (e.g., TSFa) and an AP's current TSF time is partially expressed as its current TSF [14:6] (e.g., TSFa-1), where a hexadecimal value of 0x1FF represents 511 ms on the TSF timer. In a first example, a target start time having a TSF [14:6] that is n less than the current TSF [14:6] is reserved (e.g., where n is 1, 2, 3 or more). In a second example, a target start time having a TSF [14:6] that is n greater than the current TSF [14:6] is reserved (e.g., where n is 1, 2, 3 or more).

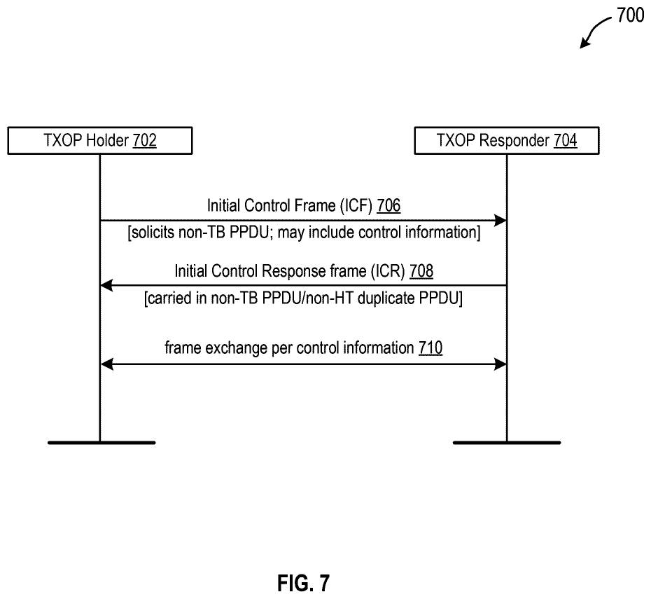

FIG. 7 illustrates an ICF/ICR frame exchange sequence 700 between a TXOP holder 702 and TXOP responder 704 in accordance with an embodiment of the present disclosure. In an example the TXOP holder 702 is an AP and the TXOP responder 704 is an associated STA. In another example, the TXOP holder 702 is a STA and the TXOP responder 704 is an AP. In operation, the TXOP holder 702 generates and transmits an Initial Control Frame (ICF) 706 to the TXOP responder 704. In an example, the ICF 706 solicits an ICR with dynamic control information or solicits an ICR without dynamic control information from a single TXOP responder 704, and includes an indication that the responsive Initial Control Response frame (ICR) shall be carried in a non-TB PPDU (e.g., a non-HT duplicate PPDU). The ICF 706 may further carry dynamic control information of the TXOP holder 702.

In response to receiving the IFC 706, the TXOP responder 704 responds with an ICR 708. The ICR 708 is carried in a non-TB PPDU/non-HT duplicate PPDU when indicated by the ICF 706. The ICF 706 may include an acknowledgment only, solicited feedback information or an implicit/explicit indication that solicited feedback information is unavailable or unknown. In various examples, the dynamic control information relates to at least one of DUO, power saving features, in-device (radio) coexistence features, per TXOP Tx/Rx parameter negotiation and TXOP allocations, dynamic sub-band switching information, etc., under the condition that at least one enabled feature needs to send the dynamic control information. In the illustrated example, further frame exchanges 710 are performed between the TXOP holder 702 and TXOP responder 704 in accordance with the previously exchanged dynamic control information.

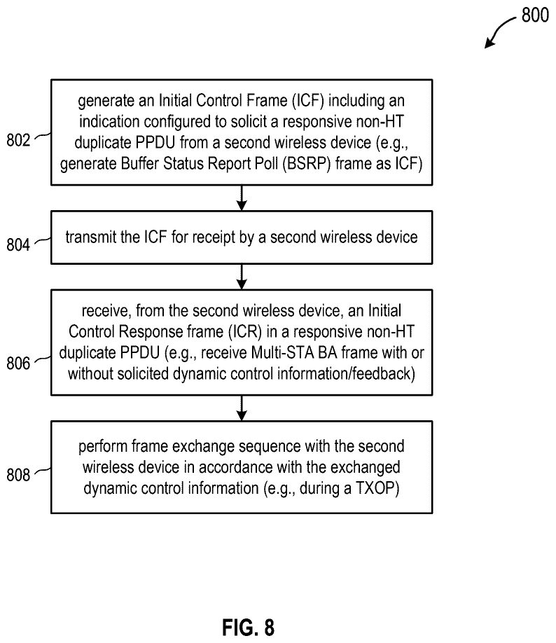

FIG. 8 is a flow chart illustrating an example method 800 for communicating dynamic control information (which may also be referred to as feedback information, feedback control information, or initial control information) or an acknowledgment only in accordance with an embodiment of the present disclosure. The method 800 can be performed by an access point (AP) and/or station (STA), such as an AP/STA affiliated with the AP MLD 102 or the STA MLD 104 described with reference to FIG. 1, or the wireless device 1000 described with reference to FIG. 10. The method 800 may be utilized, for example, to exchange dynamic control information and solicit an ICR (with or without feedback information) carried in a non-TB PPDU. The dynamic control information may relate to enhanced power saving features, DUO, in-device coexistence features, switching between capability modes, and/or other features associated with the IEEE 802.11bn amendment to the IEEE 802.11 standard where the feature requires a response with feedback information.

The method begins at step 802, where a first wireless device generates an Initial Control Frame (ICF) including an indication that is configured to solicit a responsive non-TB PPDU (e.g., a non-HT duplicate PPDU) from a second wireless device. The ICF can be a protected/unprotected Buffer Status Report Poll (BSRP) Trigger frame having a format such as described with reference to FIGS. 2-4. In an example, the ICF may carry the transmitter's unavailable information. The method continues at step 804 where the first wireless device transmits the ICF for receipt by an addressed second wireless device. The illustrated method continues at step 806, where the first wireless device receives an Initial Control Response (ICR) from the second wireless device. The ICR may be a Multi-STA BA frame having a format such as described with reference to FIGS. 5 and 6. The ICR of this example is carried in a non-TB PPDU (as solicited), and can include a requested acknowledgment and/or requested feedback/dynamic control information of the second wireless device. The method continues at step 808 where, during a TXOP, the first wireless device performs a frame exchange sequence(s) with the second wireless device in accordance with the exchanged dynamic (initial) control information.

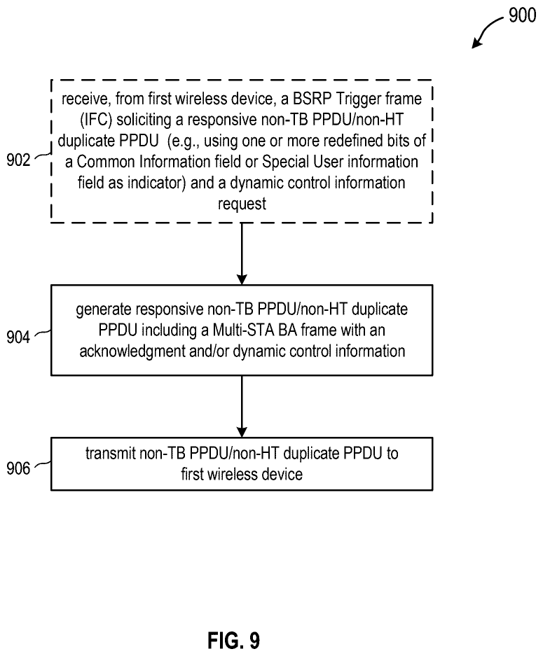

FIG. 9 is a flow chart illustrating an example method 900 for communicating an Initial Control Response frame (ICR) in a non-TB PPDU in accordance with an embodiment of the present disclosure. The method 900 can be performed by an access point (AP) and/or station (STA), such as an AP/STA affiliated with the AP MLD 102 or the STA MLD 104 described with reference to FIG. 1, or the wireless network device 1000 described with reference to FIG. 10. The method 900 may be utilized, for example, to provide a solicited acknowledgment and/or solicited feedback/dynamic control information in response to a ICF Trigger frame. The dynamic control information may relate to enhanced power saving features, DUO, in-device coexistence features, switching between capability modes, and/or other features associated with the IEEE 802.11bn amendment to the IEEE 802.11 standard.

The method begins at step 902 where a first wireless device transmits an Initial Control Frame (ICF), such as a BSRP Trigger frame, which optionally includes dynamic control information. In an example, the BSRP Trigger frame includes dynamic control information of the first wireless device. In another example, the BSRP Trigger frame includes an explicit indication that a responsive PPDU shall be a non-HT duplicate PPDU (a non-TB PPDU). In this example, the explicit indication may be carried in one or more redefined bits (e.g., a legacy Reserved bit) of a Common Information field or a Special User information field of the BSRP Trigger frame. The IFC may have a format such as the formats described with reference to FIGS. 2-4.

The method continues at step 904, where the recipient wireless device determines whether a non-TB PPDU/non-HT duplicate PPDU is indicated by the ICF for a responsive PPDU. The recipient wireless device of this example further generates a responsive non-TB PPDU/non-HT duplicate PPDU of the identified non-TB PPDU type, which includes an ICR (e.g., a Multi-STA BA frame) carrying an acknowledgment and/or the requested dynamic control information as available. In another example (not separately illustrated), if the type of responsive PPDU is not indicated by the ICF, the recipient wireless device selects a TB PPDU to carry the ICR. The recipient wireless device then transmits the non-TB PPDU/non-HT duplicate PPDU to the first wireless device at step 906.

FIG. 10 illustrates an example of a wireless device 1000 that is configured as an access point (AP) or station (STA) according to an embodiment of the present disclosure. The AP/STA 1000 is configurable to generate and receive frame formats according to any of the various embodiments described herein, and to exchange dynamic (initial) control information with one or more other wireless devices. The illustrated AP/STA 1000 includes a host processor 1002 coupled to a network interface device 1004. The network interface device 1004 includes a medium access control (MAC) processing unit 1006 and a physical layer (PHY) processing unit 1008. The PHY processing unit 1008 includes a plurality of transceivers 1010 coupled to a plurality of antennas 1012. Although three transceivers 1010 (1010-1, 1010-2 and 1010-3) and three antennas 1012 (1012-1, 1012-2 and 1012-3) arc illustrated in FIG. 1, the AP/STA 1000 includes other suitable numbers (e.g., 1, 2, 4, 5, etc.) of transceivers 1010 and antennas 1012 in other embodiments. In an example, the MAC processing unit 1006 and the PHY processing unit 1008 are configured to operate in compliance with the IEEE 802.11bn amendment to the IEEE 802.11 standard. In an example, the network interface device 1004 includes one or more integrated circuit (IC) devices. In this example, at least some of the functionality of the MAC processing unit 1006 and at least some of the functionality of the PHY processing unit 1008 can be implemented on a single IC device. As another example, at least some of the functionality of the MAC processing unit 1006 is implemented on a first IC device, and at least some of the functionality of the PHY processing unit 1008 is implemented on a second IC device. The AP/STA 1000 may communicate (e.g., C-TDMA related communications) with a plurality of client stations and/or APs, including both legacy and non-legacy client APs and stations.

In various embodiments, the PHY processing unit 1008 of the AP/STA 1000 is configured to generate data units conforming to a non-legacy communication protocol and having formats described herein. The transceiver(s) 1010 is/are configured to transmit the generated data units via the antenna(s) 1012. Similarly, the transceiver(s) 1010 is/are configured to receive data units via the antenna(s) 1012. The PHY processing unit 1008 of the AP/STA 1000 is configured to process received data units conforming to the non-legacy communication protocol and having formats described herein and to determine that such data units conform to the non-legacy communication protocol.

In an embodiment, when operating as an AP in single-user mode, the AP/STA 1000 transmits an ICF or data unit to a single client station (DL SU transmission), or receives an ICR or data unit transmitted by a single client station (UL SU transmission), without simultaneous transmission to, or by, any other client station. When operating in multi-user mode, the AP/STA 1000 transmits a data unit that includes multiple data streams for multiple client stations (DL MU transmission), or receives data units simultaneously transmitted by multiple client stations (UL MU transmission). For example, in multi-user mode, a data unit transmitted by the AP includes multiple data streams simultaneously transmitted by the AP/STA 1000 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP/STA 1000 may be configured as a multi-link device, such as the AP MLD 102 or STA MLD 104 described above with reference to FIG. 1.

While the innovative aspects of the present disclosure have been generally described in the context of the 802.11bn amendment, and future generations, of the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative apparatus, frame formats, and methods illustrated in the figures and described herein enable the efficient exchange of control information between wireless devices of a wireless network to achieve gains in overall network throughput and other potential advantages. In an illustrative, non-limiting embodiment, a method for an Initial Control Frame (ICF) and an Initial Control Response frame (ICR), with or without dynamic control information, between devices in a wireless network is provided. The method includes generating, by a first wireless device, an ICF. The ICF includes an indication configured to solicit a responsive non-HT duplicate PPDU from a second wireless device. The method further includes transmitting, by the first wireless device in a transmit opportunity (TXOP), the ICF for reception by the second wireless device.

The method of this embodiment includes optional aspects. With one optional aspect, the method further includes receiving, by the first wireless device, an Initial Control Response frame (ICR) in the responsive non-HT duplicate PPDU. In another optional aspect, the ICF relates to at least one of Dynamic Unavailability Operation (DUO), Dynamic sub-Channel Operation (DSO), Non-Primary Channel Access (NCPA), or a low-capability power save mode. In another optional aspect, the ICF further includes a receiver address (RA) field having a unicast address that identifies the second wireless device. In yet another optional aspect, the ICF is a Buffer Status Report Poll (BSRP) Trigger frame, the BSRP Trigger frame having a Common Information field and a Special User Information field.

In another optional aspect, the indication is caried in the Common Information field. In yet another optional aspect, the indication is carried in a reserved bit in the Common Information field that is redefined to indicate that the solicited PPDU is a non-HT duplicate PPDU. In a further optional aspect, the indication is carried in the Special User Info field. In another optional aspect, the indication is carried in a reserved bit in the Special User Information field that is redefined to indicate that the solicited PPDU is a non-HT duplicate PPDU.

In another optional aspect, the ICF is a Buffer Status Report Poll (BSRP) Trigger frame. In this optional aspect, the method further includes receiving, by the first wireless device, a Multi-STA Block Ack (BA) frame in the responsive non-HT duplicate PPDU, wherein the Multi-STA BA frame includes at least one Per Association ID Traffic Identifier Info field (Per AID TID Info field) having an ACK Type subfield. This optional aspect further includes determining that the Multi-STA BA frame includes dynamic control information, where an ACK Type subfield value of 0 indicates the presence of dynamic control information and an ACK Type subfield value of 1 indicates the absence of dynamic control information. In a further optional aspect, the ICF is a Buffer Status Report Poll (BSRP) Trigger frame, and the method further includes receiving, by the first wireless device, a Multi-STA Block Ack (BA) frame in the responsive non-HT duplicate PPDU, wherein the Multi-STA BA frame includes a single Per Association ID Traffic Identifier Info field (Per AID TID Info field) when the Multi-STA BA frame does not include feedback information. In this optional aspect, the Per AID TID Info field includes an AID11 subfield having a value corresponding to the first wireless device, an ACK Type subfield set to 1, and a TID subfield set to a defined value.

With another illustrative, non-limiting embodiment, a wireless device includes one or more wireless transceivers and one or more processors operably coupled to the one or more wireless transceivers. The one or more processors are arranged to generate an Initial Control Frame (ICF). In this embodiment, the ICF includes an indication configured to solicit a responsive non-HT duplicate PPDU from a second wireless device. The one or more processors of the wireless device are further arranged to transmit, via the one or more wireless transceivers in a transmit opportunity (TXOP), the ICF for reception by the second wireless device.

This second embodiment includes optional aspects. With one optional aspect, the one or more processors are further arranged to receive, via the one or more wireless transceivers, an Initial Control Response frame (ICR) in the responsive non-HT duplicate PPDU. In another optional aspect, the ICR includes dynamic control information that relates to at least one of Dynamic Unavailability Operation (DUO), Dynamic sub-Channel Operation (DSO), Non-Primary Channel Access (NCPA), or a low-capability power save mode.

In yet another optional aspect, the ICF is a Buffer Status Report Poll (BSRP) Trigger frame having a Common Information field and a Special User Information field. In another optional aspect, the indication is carried in the Common Information field. In yet another optional aspect, the indication is carried in a reserved bit in the Common Information field that is redefined to indicate that the solicited PPDU is a non-HT duplicate PPDU.

In another illustrative, non-limiting embodiment, a method for exchanging dynamic control information between devices in a wireless network is provided. The method includes generating, by a first wireless device, an Initial Control Frame (ICF). The ICF is configured to solicit an unavailable time from a second wireless device. The method of this embodiment further includes transmitting, by the first wireless device, the ICF for reception by the second wireless device. The method further includes receiving, by the first wireless device, an Initial Control Response frame (ICR) in a responsive non-HT duplicate PPDU. The ICR includes an Unavailability Target Start Time field including a defined value that indicates either no unavailable time or an unknown unavailable time. This third embodiment includes optional aspects. With one optional aspect, the defined value is one of all zeroes or all ones.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for exchanging an Initial Control Frame (ICF) and an Initial Control Response frame (ICR), with or without dynamic control information, between devices in a wireless network, the method comprising:
generating, by a first wireless device, an ICF including an indication configured to solicit a responsive non-High Throughput duplicate physical layer protocol data unit (non-HT duplicate PPDU) from a second wireless device; and
transmitting, by the first wireless device in a transmit opportunity (TXOP), the ICF for reception by the second wireless device.

2. The method of claim 1, further comprising:
receiving, by the first wireless device, an Initial Control Response frame (ICR) in the responsive non-HT duplicate PPDU.

3. The method of claim 1, wherein the ICF relates to at least one of Dynamic Unavailability Operation (DUO), Dynamic Sub-channel Operation (DSO), Non-Primary Channel Access (NCPA), or a low-capability power save mode.

4. The method of claim 1, wherein the ICF further includes a receiver address (RA) field having a unicast address that identifies the second wireless device.

5. The method of claim 1, wherein the ICF is a Buffer Status Report Poll (BSRP) Trigger frame, the BSRP Trigger frame having a Common Information field and a Special User Information field.

6. The method of claim 5, wherein the indication is carried in the Common Information field.

7. The method of claim 6, wherein the indication is carried in a reserved bit in the Common Information field that is redefined to indicate that the solicited PPDU is a non-HT duplicate PPDU.

8. The method of claim 5, wherein the indication is carried in the Special User Info field.

9. The method of claim 8, wherein the indication is carried in a reserved bit in the Special User Information field that is redefined to indicate that the solicited PPDU is a non-HT duplicate PPDU.

10. The method of claim 1, wherein the ICF is a Buffer Status Report Poll (BSRP) Trigger frame, the method further comprising:
receiving, by the first wireless device, a Multi-STA Block Ack (BA) frame in the responsive non-HT duplicate PPDU, wherein the Multi-STA BA frame includes at least one Per Association ID Traffic Identifier Info field (Per AID TID Info field) having an ACK Type subfield; and
determining whether or not the Multi-STA BA frame includes dynamic control information, wherein an ACK Type subfield value of 0 indicates the presence of dynamic control information and an ACK Type subfield value of 1 indicates the absence of dynamic control information.

11. The method of claim 1, wherein the ICF is a Buffer Status Report Poll (BSRP) Trigger frame, the method further comprising:
receiving, by the first wireless device, a Multi-STA Block Ack (BA) frame in the responsive non-HT duplicate PPDU, wherein the Multi-STA BA frame includes a single Per Association ID Traffic Identifier Info field (Per AID TID Info field) when the Multi-STA BA frame does not include feedback information, and wherein the Per AID TID Info field includes:
an AID11 subfield having a value corresponding to the first wireless device;
an ACK Type subfield set to 1; and
a TID subfield set to a defined value.

12. A wireless device, comprising:
one or more wireless transceivers; and
one or more processors operably coupled to the one or more wireless transceivers, wherein the one or more processors are arranged to:
generate an Initial Control Frame (ICF), the ICF including an indication configured to solicit a responsive non-High Throughput duplicate physical layer protocol data unit (non-HT duplicate PPDU) from a second wireless device; and
transmit, via the one or more wireless transceivers in a transmit opportunity (TXOP), the ICF for reception by the second wireless device.

13. The wireless device of claim 12, wherein the one or more processors are further arranged to:
receive, via the one or more wireless transceivers, an Initial Control Response frame (ICR) in the responsive non-HT duplicate PPDU.

14. The wireless device of claim 13, wherein the ICR includes dynamic control information that relates to at least one of Dynamic Unavailability Operation (DUO), Dynamic Sub-channel Operation (DSO), Non-Primary Channel Access (NCPA), or a low-capability power save mode.

15. The wireless device of claim 12, wherein the ICF is a Buffer Status Report Poll (BSRP) Trigger frame, the BSRP Trigger frame having a Common Information field and a Special User Information field.

16. The wireless device of claim 15, wherein the indication is carried in the Common Information field.

17. The wireless device of claim 16, wherein the indication is carried in a reserved bit in the Common Information field that is redefined to indicate that the solicited PPDU is a non-HT duplicate PPDU.

18. The wireless device of claim 12, wherein the ICF is a Buffer Status Report Poll (BSRP) Trigger frame and the one or more processors are further arranged to:
receive, via the one or more wireless transceivers, a Multi-STA Block Ack (BA) frame in the responsive non-HT duplicate PPDU, wherein the Multi-STA BA frame includes at least one Per Association ID Traffic Identifier Info field (Per AID TID Info field) having an ACK Type subfield; and
determining whether or not the Multi-STA BA frame includes dynamic control information, wherein an ACK Type subfield value of 0 indicates the presence of dynamic control information and an ACK Type subfield value of 1 indicates the absence of dynamic control information.

19. A method for exchanging dynamic control information between devices in a wireless network, the method comprising:
generating, by a first wireless device, an Initial Control Frame (ICF), the ICF configured to solicit an unavailable time from a second wireless device;
transmitting, by the first wireless device, the ICF for reception by the second wireless device; and
receiving, by the first wireless device, an Initial Control Response frame (ICR) in a responsive non-HT duplicate PPDU, wherein the ICR includes an Unavailability Target Start Time field including a defined value that indicates either no unavailable time or an unknown unavailable time.

20. The method of claim 19, wherein the defined value is one of all zeroes or all ones.
